(19) United States
(12) Patent Application Publication
(10) Pub. No.: US 2013/0330631 A1
(43) Pub. Date: Dec. 12, 2013

(54) BATTERY AND METHOD OF MANUFACTURING A BATTERY

(71) Applicant: EAGLEPICHER TECHNOLOGIES, LLC, Joplin, MO (US)

(72) Inventor: Daniel Glen FARRELL, Burnaby (CA)

(73) Assignee: EAGLEPICHER TECHNOLOGIES, LLC, Joplin, MO (US)

(21) Appl. No.: 13/772,772

(22) Filed: Feb. 21, 2013

Related U.S. Application Data
(60) Provisional application No. 61/657,468, filed on Jun. 8, 2012.

(51) Int. Cl. H01M 10/04

(52) U.S. Cl. CPC H01M 10/04; H01M 10/0404
USPC 429/246; 29/729; 29/623.1

(57) ABSTRACT

Methods of manufacturing a battery include the steps of forming a plurality of cathodes that each include a flag tab of a securing profile, forming a plurality of anodes that each include a tabbed portion of a securing profile, and stacking the cathodes and the anodes to create an electrode stack. The stacking step includes the steps of layering in alternating order the anodes and the cathodes with at least one layer of separator physically insulating each anode from each cathode, aligning the cathodes with a first alignment means, and aligning the anodes with a second alignment means.

### CROSS REFERENCE TO RELATED APPLICATION

This application claims the benefit of U.S. Provisional Patent Application No. 61/657,468, filed Jun. 8, 2012, which is incorporated by reference herein in its entirety.

### TECHNICAL FIELD

The present invention relates to batteries and methods of manufacturing batteries.

### BACKGROUND

Electrical batteries are used in a wide variety of applications requiring a reliable portable power source. In some applications, such as implantable medical devices on which patients depend for their physical health, reliable performance of a battery is particularly critical. Accordingly, defects that impact the reliability and performance of a battery must be minimized.

Some defects are introduced during the manufacturing process. Electrical batteries typically have one or more electrochemical cells that store chemical energy and convert the stored chemical energy into electrical energy via electrochemical reactions. The electrochemical cells convert chemical energy to electrical energy by a redox reaction that occurs between electrodes, i.e., cathodes and anodes. The redox reaction requires that the cathodes are electrically connected to the anodes, but to ensure proper functioning of a battery, the cathodes should not make physical contact with the anodes or else a short circuit may occur, thereby negatively impacting the performance and lifespan of a battery. Thus, there is a need to prevent the cathodes and anodes from making physical contact with each other during manufacturing and use of the battery.

### SUMMARY

The natural property of cathodes to expand and anodes to contract during battery use tends to complicate the manufacturing process. In particular, at the Beginning of Life (BOL) when a battery has not begun to significantly discharge, a cathode is at its smallest size. During discharge, the cathode may expand to such a size so as to make contact with an anode either directly or indirectly through an electrically-conductive path, a stabilizing element, and/or an electrochemical cell housing. At the End of Life (EOL) when the battery is discharged, the cathode is at its largest size. When a cathode expands to a sufficiently large size during discharge so as to make contact with an anode either directly or indirectly through an electrically-conductive path, a stabilizing element, and/or an electrochemical cell housing, a short circuit may occur thereby rapidly reducing the lifespan and performance of the battery. The problem is especially prevalent in stacked cell batteries where the electrodes are stacked on top of one another.

Accordingly, certain methods have been employed to mitigate this problem. One method is to make the cathodes sufficiently small so as to ensure that they cannot expand to a size that would cause them to make contact with anodes either directly or indirectly through an electrically-conductive path, a stabilizing element, and/or an electrochemical cell housing. However, this method reduces the power capacity of the battery.

Another method, particularly applicable to stacked cell batteries, is to attempt to properly align the electrodes within the battery, since cell housings are generally designed for properly aligned electrodes. Misaligned electrodes may create a situation in which expanding cathodes may make contact with anodes causing a short circuit. However, current methods for ensuring proper alignment of electrodes are insufficient.

The exemplary embodiments relate to manufacturing a battery with properly aligned electrodes that remain aligned during and after manufacturing (i.e., within cells), thereby minimizing the possibility of short circuits. Due to a reduced possibility of short circuits, the need to reduce the size of electrodes is also minimized. This allows for larger electrodes to be used, which allows for more power output from batteries manufactured by the processes.

The exemplary embodiments relate to methods of manufacturing a battery. The methods include the steps of forming a plurality of cathodes that each include a flag tab of a first securing profile, foaming a plurality of anodes that each include a tabbed portion of a second securing profile, and stacking the cathodes and the anodes to create an electrode stack. The stacking step includes the steps of layering in alternating order the anodes and the cathodes with at least one layer of separator physically insulating each anode from each cathode, aligning the cathodes with a first alignment means, and aligning the anodes with a second alignment means.

In some embodiments, the forming of the cathodes includes (i) aligning each flag tab to a corresponding cathode by aligning the flag tab and the cathodes with an alignment means, and (ii) welding each of the flag tabs to the corresponding cathode. Aligning the various components properly helps ensure proper overall alignment of the electrodes.

In some embodiments, each anode and the corresponding tabbed portion define a unitary structure if the anode is made from one piece, and at least one component of each anode and the corresponding tabbed portion define a unitary structure if the anode is made from more than one piece. This can reduce manufacturing costs.

In some embodiments, aligning the cathodes occurs simultaneously with aligning the anodes. This can ensure additional accuracy during the aligning steps.

In some embodiments, the methods further include stabilizing the electrode stack with a header, wherein the stacking step includes welding at least one flag tab to a pin of the header using an open-face weld.

In some embodiments, the methods further include stabilizing the electrode stack with a header, wherein the stacking step further includes welding at least one tabbed portion to the header using an open-face weld.

In some embodiments, the stacking step further includes welding the plurality of tabbed portions together using an open-face gang weld.

In some embodiments, the stacking step further includes bending the tabbed portions to be parallel to a plane of a thickness side of the cathodes. In addition, the bending step may further include making a bend in the tabbed portion at a predetermined distance from the nearest cathode sufficient to allow for the cathode to expand to a predetermined size without making contact with the tabbed portion. Further, the stacking step may further include wrapping a portion of the edges of the cathodes closest to the tabbed portions with an electrically-insulating material.

In some embodiments, the method further includes processing the flag tabs and the tabbed portions so as to rid the electrode stack of protrusions that would prevent the electrode stack from fitting within an electrochemical cell housing. The processing step may also include cutting off the flag tabs from the cathodes and the tabbed portions from the anodes.

Another aspect of the invention includes batteries manufactured by the exemplary methods.

In some embodiments, the method may further include encapsulating at least one edge of the electrode stack with a wing insulator that includes (1) a spine with a width substantially the same as a thickness of the electrode stack, and (2) at least two wings extending substantially perpendicular to a major plane of the spine, the wings enclosing a thickness edge of the electrode stack and at least a portion of both sides of the electrode stack, and insulating the electrode stack from a header and/or an electrochemical cell housing with the wing insulator.

Another aspect of the invention relates to a wing insulator for encapsulating at least one edge of an electrode stack including (1) a spine with a width substantially the same as a thickness of the electrode stack, and (2) at least two wings extending perpendicular to a major plane of the spine, the at least two wings enclosing the at least one edge of the electrode stack on both sides of the electrode stack.

Another aspect of the invention relates to an assembly for manufacturing a battery including attaching means for attaching a plurality of flag tabs that each define at least one flag tab tooling hole to a plurality of cathode tabs of a plurality of cathodes, forming means for forming a plurality of anodes that each include a tabbed portion that defines at least one tabbed portion tooling hole, and stacking means for stacking the cathodes and the anodes to create an electrode stack. The stacking means includes a first aligning means for aligning the cathodes by inserting at least one flag tab alignment rod through at least one flag tab tooling hole of each flag tab, and a second aligning means for aligning the anodes by inserting at least one tabbed portion alignment rod through at least one tabbed portion tooling hole of each tabbed portion. The anodes and the cathodes are layered in alternating order with at least one layer of separator physically insulating each anode from each cathode.

### BRIEF DESCRIPTION OF THE DRAWINGS

Various exemplary embodiments of a battery manufacturing process to which aspects of the invention are applied will be described in detail with reference to the following drawings in which:

FIG. 1 shows a cathode with a triangle tab;

FIGS. 2A-2D show a cathode with a flag tab in various embodiments;

FIG. 3 shows an anode with a straight tab;

FIG. 4A shows an anode with a tabbed portion in an embodiment;

FIG. 4B shows an anode in an embodiment;

FIG. 5 shows a method of creating an electrode stack with a plurality of cathodes and anodes;

FIG. 6A shows an open-face layered assembly method for stacking the electrodes in an embodiment;

FIG. 6B shows an assembly with electrodes mounted thereon and tooling holes penetrated by the alignment rods and aligned from a perspective perpendicular to the major planes of the electrodes in an embodiment;

FIGS. 7A-7B show a result of a method of welding the straight tabs of anodes together;

FIG. 8 shows an open-face weld for the anodes in an embodiment;

FIG. 9A shows an electrode stack with a header in an embodiment;

FIG. 9B shows an electrode stack connected to the header by at least two tabs in an embodiment;

FIG. 10 shows a method of an enclosed, two-step weld for connecting the cathodes in an electrode stack to a header;

FIG. 11 shows an open-face weld for the cathode header tab in an embodiment;

FIG. 12 shows a method of resistance welding an anode to a header;

FIG. 13A shows an open-face weld for the anode header tab in an embodiment;

FIG. 13B shows a wing insulator in an embodiment;

FIG. 13C shows a wing insulator in an embodiment;

FIG. 14A shows a method of bending anode tabs so that the anodes are in physical contact with each other;

FIG. 14B shows a method of accounting for cathode expansion;

FIG. 15A shows tabbed portions of the anodes in an embodiment;

FIG. 15B shows tabbed portions of the anodes in an embodiment;

FIG. 15C shows a top view in which all of the flag tabs and all of the tabbed portions are bent in an embodiment;

FIG. 15D shows a cathode with an electrically-insulating material applied to the edge of the cathode nearest the bent portion of the anode in an embodiment;

FIG. 16 shows a processed electrode stack in an embodiment; and

FIG. 17 is a flowchart of a manufacturing process according to embodiments of the invention.

### DETAILED DESCRIPTION OF EMBODIMENTS

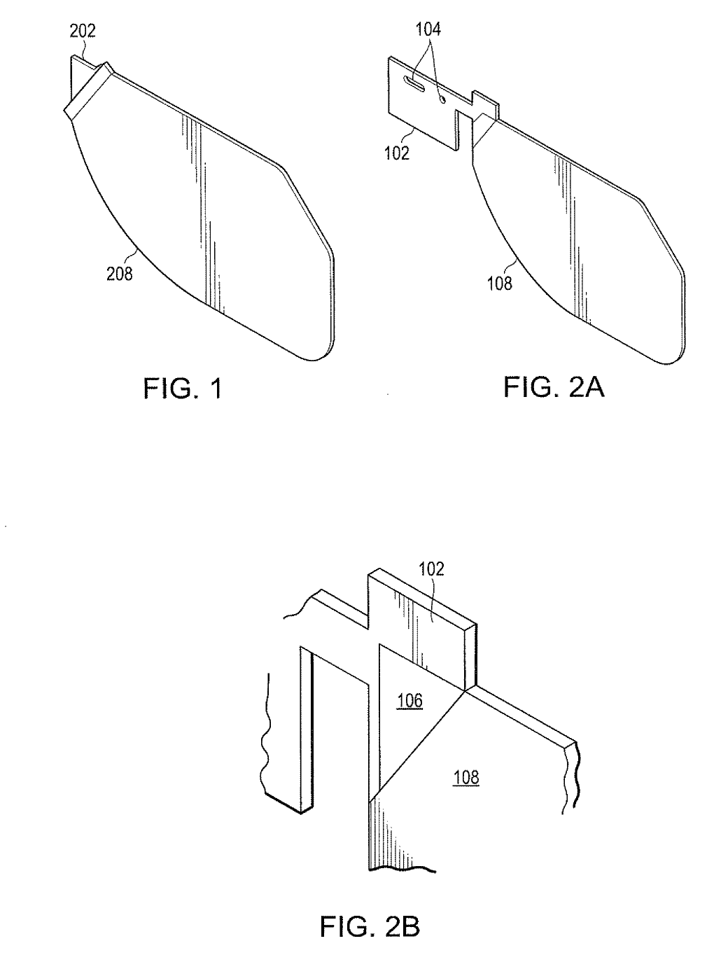

Embodiments of the invention are described below with reference to FIGS. 1-17.

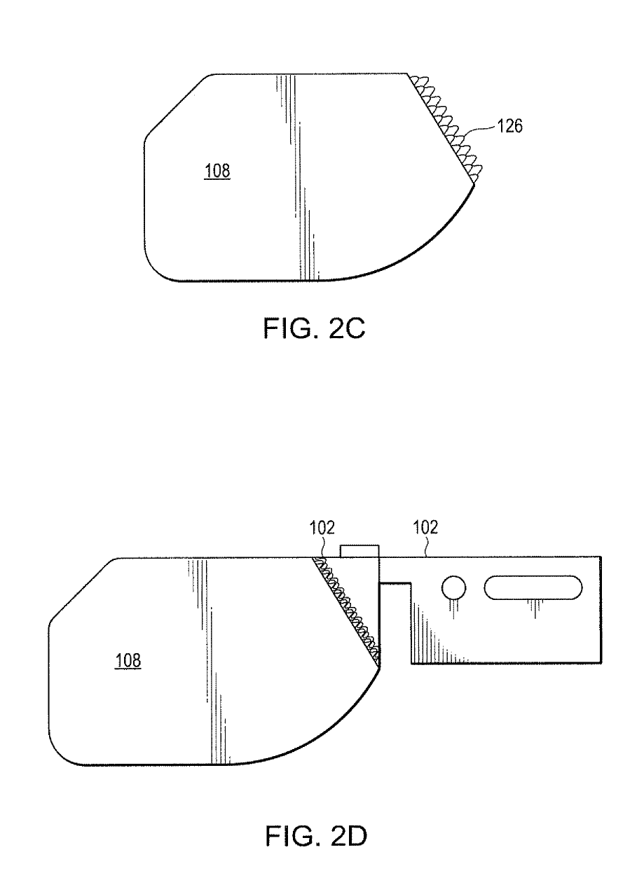

FIG. 1 shows a cathode 208 with a triangle, or triangular, tab 202. The triangle tab 202 serves as a welding area to attach the cathode 208 to other components within a battery. The triangle tab 202 is welded to cathode exmet (see FIG. 2C) to secure it to the cathode 208. The triangle tab 202 is manufactured to be small relative to the overall size of the cathode 208, since the power capacity of a battery is a direct function of the size of the electrodes, not the size of the triangle tabs 202. However, the relatively small size of the triangle tab 202 makes it difficult to properly align the cathodes 208 when manufacturing a battery.

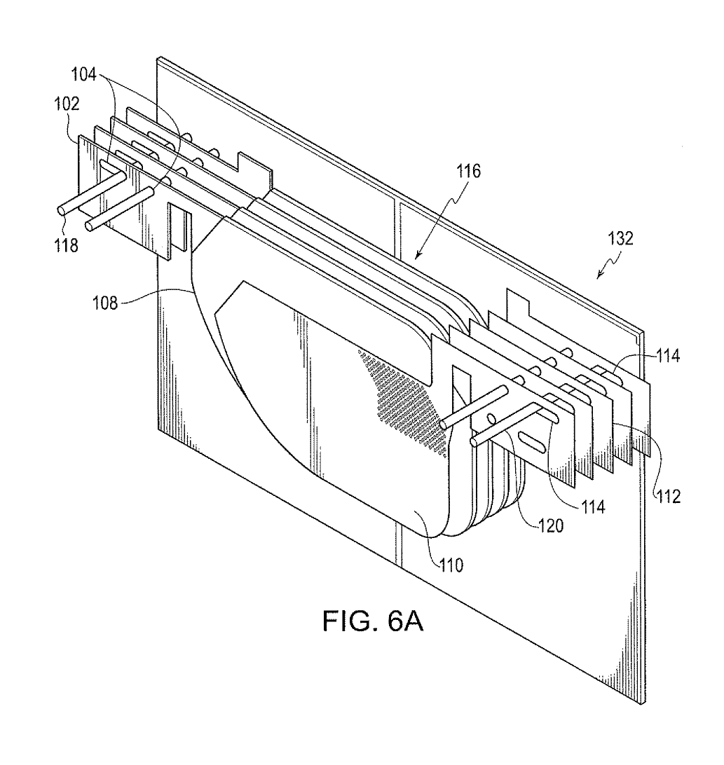

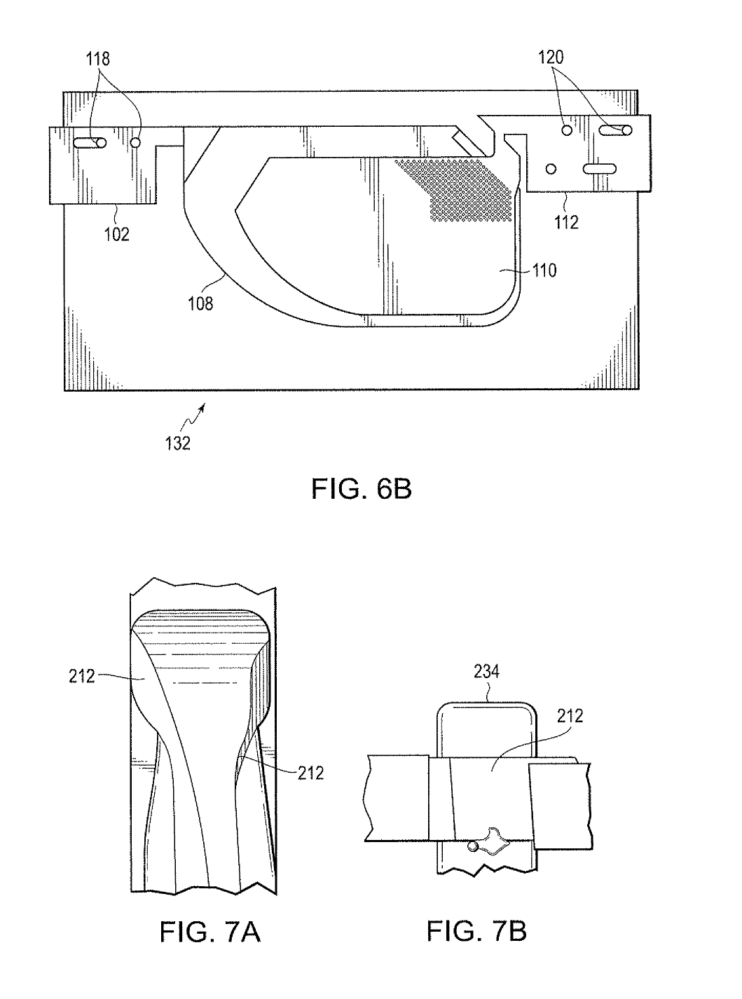

FIG. 2A shows a cathode 108 with a flag tab 102 in an embodiment. In this embodiment, the flag tab 102 is a structure that is designed to be attached to the cathode 108 and/or components attached to the cathode 108. Upon attachment or forming, the flag tab 102 may be considered a component of the cathode 108. The flag tab 102 can be attached to a triangle tab 106 that is already attached to the cathode 108 (see FIG. 2B), but preferably, it is attached directly to the cathode 108 (see FIG. 2C). The flag tab 102 can be attached directly to exmet 126 that is attached to an edge of the cathode 108 (see FIG. 2D). The exmet 126 is preferably laminated to an edge of the cathode 108. The flag tab 102 can be attached directly or indirectly to the cathode in any number of ways including, but not limited to, welding (such as ultrasonic welding), gluing, screwing, nailing, and it is preferably welded to 100% of the exposed portion of the triangle tab 106 as shown in FIG. 2B. Preferably, the flag tabs 102 are aligned to the cathodes 108 uniformly. Even more preferably, the flag tabs 102 are aligned to the cathodes 108 using the below-discussed alignment means (see, e.g., FIGS. 6A, 6B, 9B, and 15C). This ensures additional stability during an alignment process.

The flag tab 102 may be any shape. Preferably, the flag tab 102 is substantially rectangular along its major plane for ease of manufacturing. The flag tab 102 may be any size. Preferably, the flag tab 102 is substantially larger than the triangle tab 106 to improve the alignment of the electrodes. The flag tab 102 may be made from any manufacturing process including, but not limited to, stamping, machining, laser cutting, molding, and any combination thereof. The flag tab 102 may be made out of any solid material that, preferably, maintains its form under moderate amounts of stress including, but not limited to, metal, composite, polymer, and any combination thereof.

In exemplary embodiments, the flag tab 102 has a securing profile. A securing profile is a shape or topography that has one or more grooves, holes, divots, teeth, bumps, coils, hooks, penannular sections, scallops, threads, sockets, protrusions, indentations and/or any other physical attributes that allow for an alignment means to secure the object (here, a flag tab). An alignment means can be a rod, a clamp, a vise, a bolt, an anchor, a ring, a rivet, a socket, a screw, a hanger, a pin, a clip, a strut, and/or any other device for aligning and/or securing an object.

In a preferred embodiment, the flag tab 102 has, as part of its securing profile, at least one tooling hole 104 that can receive, as an alignment means, an alignment rod 118 (see FIG. 6A). FIG. 2A shows two tooling holes 104 of different sizes that are substantially at the same height level. However, the tooling holes 104 can be placed or formed anywhere on the flag tab 102 as required by an alignment process. Preferably, there are two or more tooling holes 104 with a substantial distance between them to improve stability when rods are placed through them. The tooling holes 104 may be any size and shape, but are preferably shaped to approximate a shape of an alignment device that will enter the tooling holes 104 during alignment.

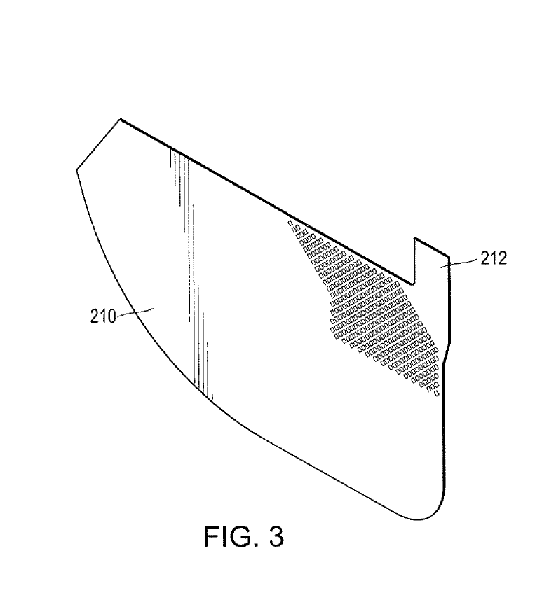

FIG. 3 shows an anode 210 with a straight tab 212. The straight tab 212, similar to the triangle tab 202 of the cathode 208, serves as a welding area to attach the anode 210 to other components within a battery. The straight tab 212 is manufactured to be small relative to the overall size of the anode 210, since the power capacity of a battery is a direct function of the size of the electrodes, not the size of the straight tabs 212. However, the relatively small size of the straight tab 212 makes it difficult to properly align the anodes 210 when manufacturing a battery.

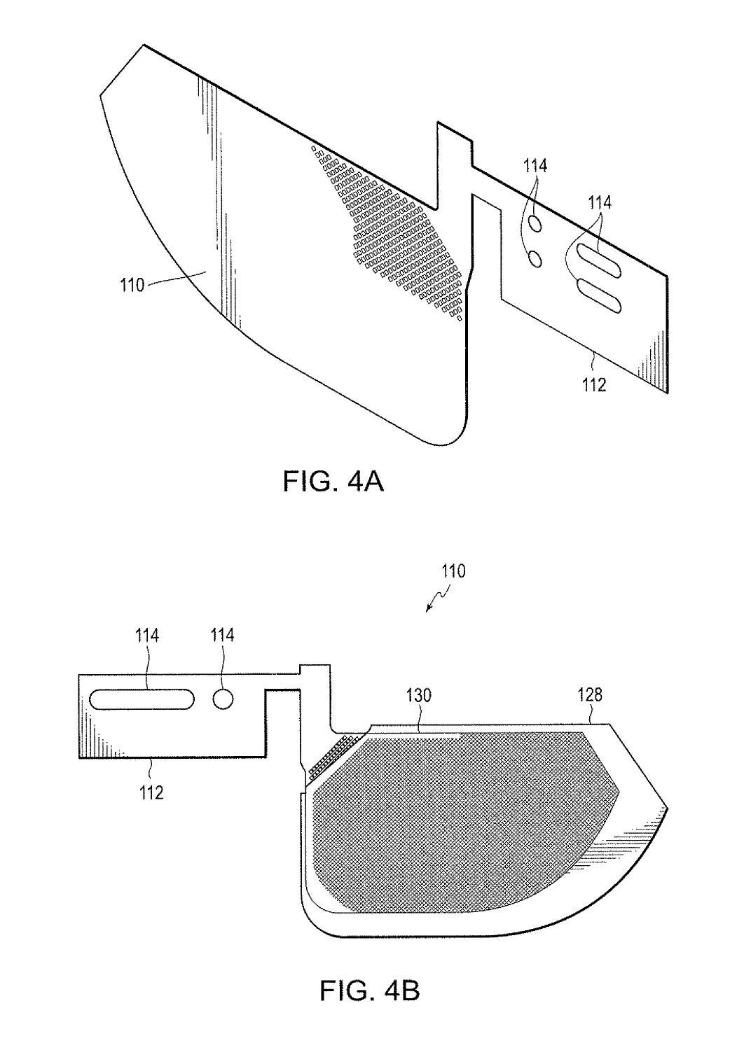

FIG. 4A shows an anode 110 with a tabbed portion 112 in an embodiment. FIG. 4B shows an embodiment in which an anode 110 includes at least two components: an anode base 128 and a current collector 130. Upon attachment or forming, the tabbed portion 112 may be considered a component of the anode 110. The anode base 128 and the current collector 130 may be made out of any number of known materials for making the two components. For example, the anode base 128 can be made of solid lithium, while the current collector 130 can be punched from a sheet of nickel. In an embodiment, the tabbed portion 112 is a structure that is designed to be attached to the anode 110 and/or components attached to the anode 110. For example, the tabbed portion 112 can be attached directly to the anode base 128, and preferably, it is formed of a unitary structure with the current collector 130 with a material that is sufficiently hard to maintain its form under moderate amounts of stress. The unitary structure including current collector 130 and tabbed portion 112 can be formed in any number of ways including, but not limited to, stamping, machining, laser cutting, molding, and any combination thereof, but it is preferably nickel-stamped from a single larger piece of material. This ensures additional stability during an alignment process.

The tabbed portion 112 may be any shape. Preferably the tabbed portion 112 is substantially rectangular along its major plane for ease of manufacturing. The tabbed portion 112 may be any size. Preferably, the tabbed portion 112 is substantially larger than a straight tab 212 (see FIG. 3) to improve the alignment of the electrodes. The tabbed portion 112 may be made from any manufacturing process including, but not limited to, stamping, machining, laser cutting, molding, and any combination thereof. If the tabbed portion 112 is formed of a unitary structure with the anode 110, the anode 110 and the tabbed portion 112 are preferably made from the same manufacturing process. The tabbed portion 112 may be made out of any solid material that, preferably maintains its form under moderate amounts of stress including, but not limited to, metal, composite, polymer, and any combination thereof. If the tabbed portion 112 is formed of a unitary structure with the anode 110, the anode 110 and the tabbed portion 112 are preferably made out of the same solid material.

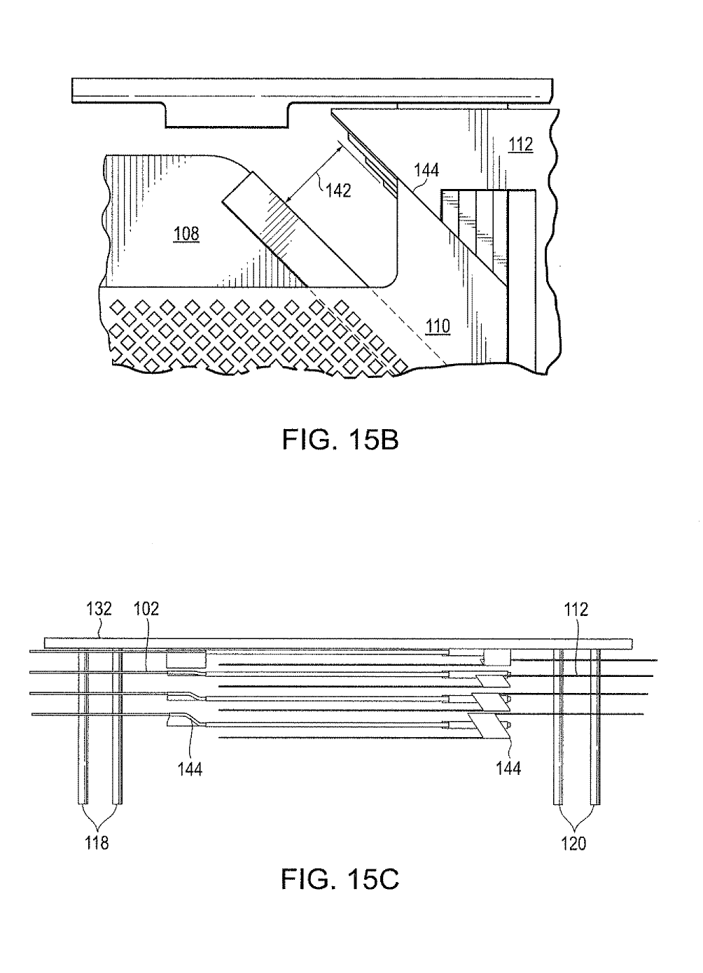

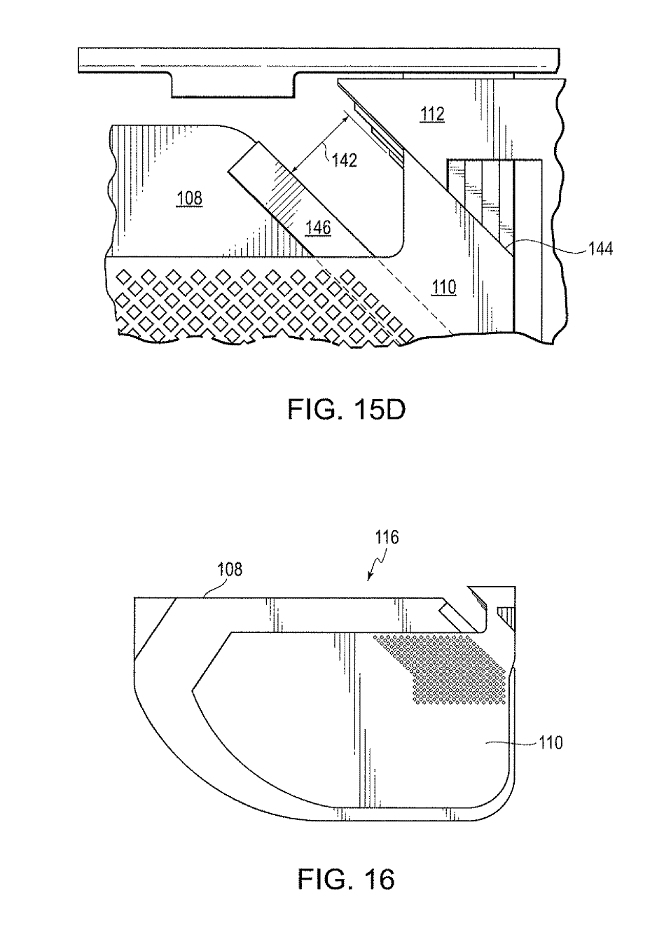

In exemplary embodiments, the tabbed portion 112 has a securing profile. In a preferred embodiment, the tabbed portion 112 has, as part of its securing profile, at least one tooling hole 114 that can receive, as an alignment means, an alignment rod 120 (see FIG. 6A). FIG. 4A shows four tooling holes 114 of varying sizes that are substantially symmetrical across a line parallel to a top edge of the anode 110 in an embodiment. The top two holes may be used to align the anodes 110 during stacking, and each anode's tabbed portion may have the top two holes in slightly different locations (e.g., with an approximately 0.020 inch offset from an adjacent anode's tabbed portion) so when the tabbed portions are bent in succession (see FIGS. 15A and 15B), the anode bodies will be evenly aligned when stacked. The bottom two holes may be used for the same or other alignment processes. For example, they may be used to align each individual anode in a lithium stamping machine (not shown). These two holes may be at the same relative location on each tabbed portion so that every anode will have their lithium portion punched identically.

However, the tooling holes 114 can be placed or formed anywhere on the tabbed portion 112 as required by an alignment process. Preferably, there are two or more tooling holes 114 with a substantial distance between them to improve stability when rods are placed through them. The tooling holes 114 may be any size and shape, but are preferably shaped to approximate a shape of an alignment device that will enter the tooling holes 114 during alignment.

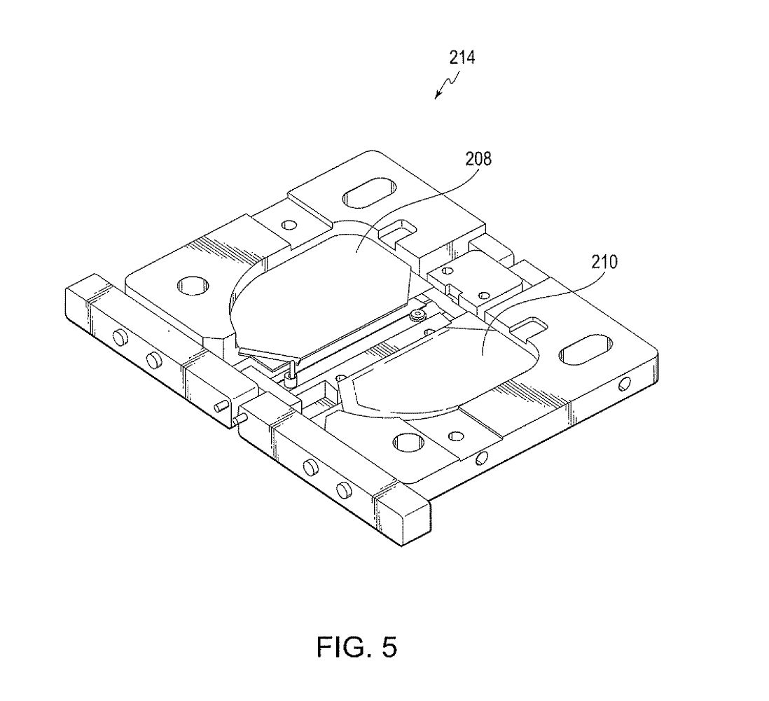

FIG. 5 shows a device in use during part of a method of creating an electrode stack with a plurality of cathodes and anodes. This particular method utilizes a butterfly assembly 214, which is a hinged device with two receiving halves each of which hold at least one electrode. After placing the electrodes in the receiving halves, the assembly is folded and the electrodes connected. The process is iteratively repeated until the electrode stack is complete. However, this process may introduce alignment and welding difficulties.

FIG. 6A shows an open-face layered assembly method for stacking the electrodes in a preferred embodiment. Herein, the term “stacking” refers to a general process of some embodiments where the process includes one or more steps to create an electrode stack, rather than only a physical act of placing objects on top of one another. In an embodiment, an anode 110 (with tabbed portion 112) is first installed on an assembly 132 so that at least one tabbed portion alignment rod 120 connected to the assembly 132 enters at least one tooling hole 114 of the tabbed portion 112. The major plane of the anode 110 is substantially parallel to the major plane of the assembly 132. Then, a cathode 108 (with flag tab 102) is installed on the assembly 132 so that at least one flag tab alignment rod 118 connected to the assembly 132 enters at least one tooling hole 104 of the flag tab 102. The major plane of the cathode 108 is substantially parallel to the major plane of the assembly 132. These two installations repeat until before the last anode is installed. The last anode is installed in a similar process to the first anode. As each electrode is installed, the electrode has a face that is open and accessible.

The flag tabs 102 are all properly aligned to each other since the same straight flag tab alignment rods 118 penetrate the corresponding holes 104 on each flag tab 102. Since all of the flag tabs 102 are aligned to the main bodies of the cathodes 108, the main bodies of the cathodes 108 themselves are aligned to each other by the principle of transitivity. The tabbed portions 112 are all properly aligned to each other since the same tabbed portion alignment rods 120 penetrate the corresponding holes 114 on each tabbed portion 112. Since all of the tabbed portions 112 are aligned to the main bodies of the anodes 110, the main bodies of the anodes 110 themselves are aligned to each other by the principle of transitivity.

FIG. 6B shows an assembly 132 with electrodes mounted thereon and tooling holes penetrated by the alignment rods and aligned from a perspective perpendicular to the major planes of the electrodes (i.e., open-face), in an embodiment. Preferably, alignment of the anodes 110 and alignment of the cathodes 108 occur simultaneously.

Thus, the tooling holes of the flag tabs 102 and tabbed portions 112 ensure more accurate alignment than is typically achieved without the flag tabs, tabbed portions, and the corresponding tooling holes. Further, providing a preferably greater distance between the tooling holes on the flag tabs and tabbed portions increases the quality of alignment.

Advantages of the open-face assembly method for stacking the electrodes are also discussed below.

FIGS. 7A and 7B show a result of a method of welding the straight tabs 212 of anodes 210 together. In the method, the straight tabs 212 are welded together in an enclosed, three-step gang weld, which results in alignment and welding difficulties.

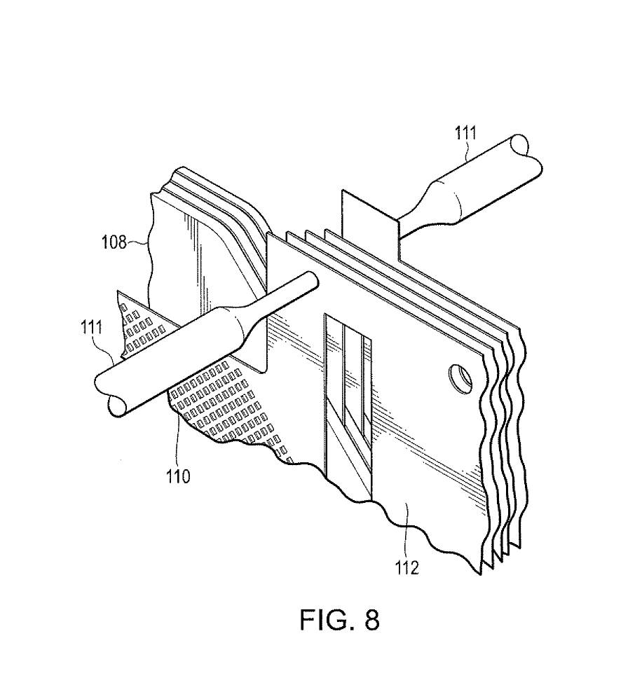

FIG. 8 shows an open-face weld for the anodes 110 in a preferred embodiment. In the open-face layered assembly method for stacking the electrodes, the anodes 110 each have an outward-facing (away from the assembly 132), openly accessible face while secured by the assembly 132 and alignment rods 120. Forming the anodes 110 with tabbed portions 112 yields a significant and repeatable feature to secure the anode 110 during welding. The open-face layered assembly method minimizes lateral movement of the anodes 110 during welding since the alignment rods 120 secure the anodes 110 while they are on the assembly 132. Thus, the method facilitates easy access to gang welding the straight portions of the tabbed portions 112 of the anodes 110. Here, the straight portions of the tabbed portions 112 of the anodes 110 are welded together with a welder 111, but the anodes 110 may be welded together with the foregoing advantage of the embodiment at any location on the anode body. Cathodes (e.g., triangle tabs and/or flag tabs) may be similarly welded if so required.

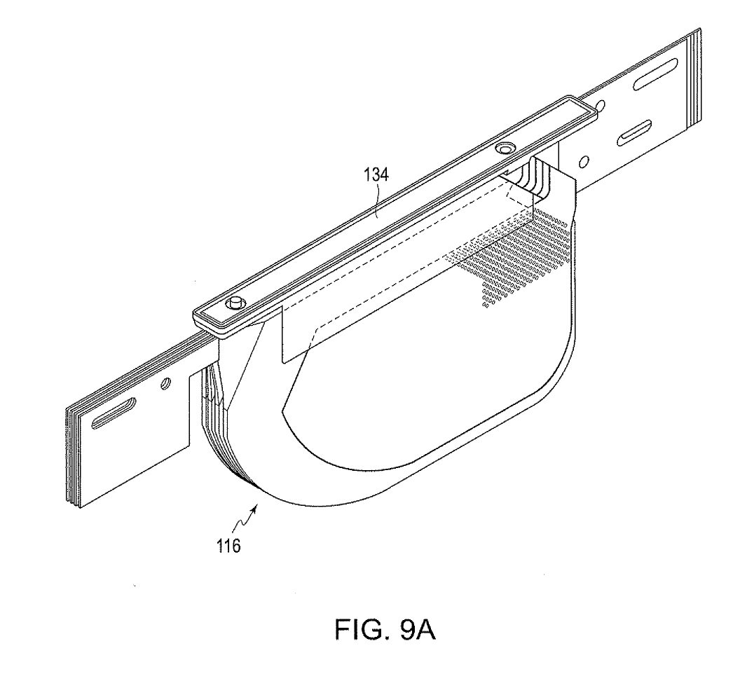

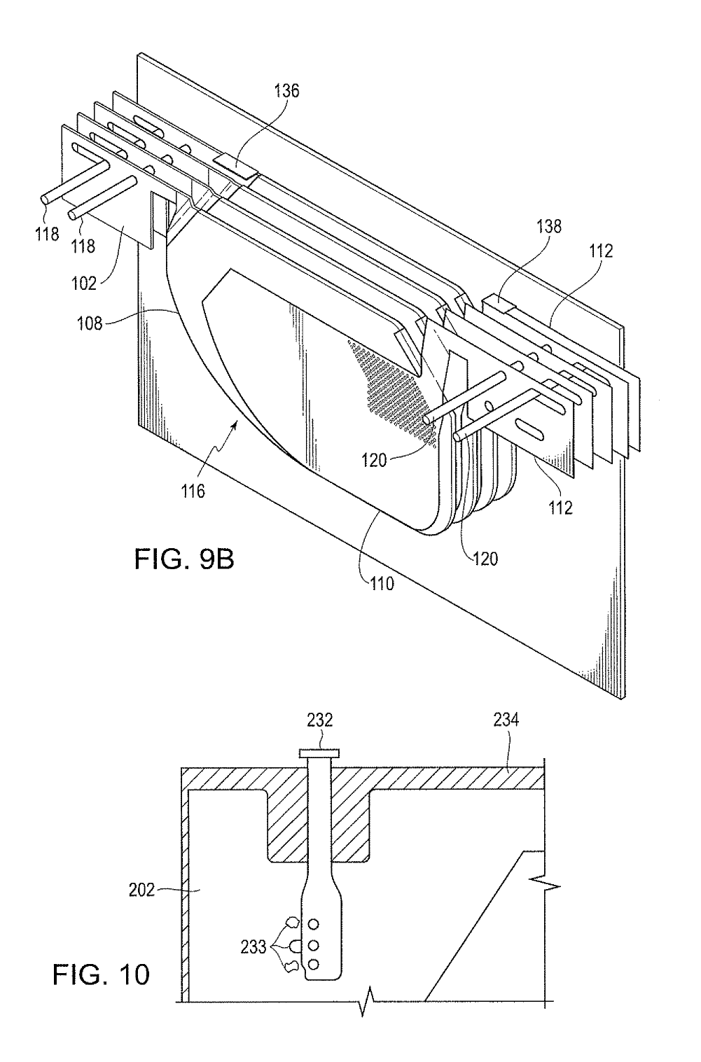

FIG. 9A shows an electrode stack 116 with a header 134 in an embodiment. The header 134 serves several purposes including securing the electrode stack 116 before insertion into an electrochemical cell housing or can (not shown), and securing the electrode stack 116 while it is in the housing. FIG. 9B shows an embodiment wherein the electrode stack 116 is connected to the header 134 by at least two tabs: a cathode header tab 136 and an anode header tab 138. Preferably, the cathode header tab 136 protrudes taller than the other cathodes from an outermost cathode tab or flag tab (an outermost tab being a tab connected to a cathode that is not sandwiched by two other cathodes in the electrode stack). However, the cathode header tab 136 may be connected to any of the cathodes. Preferably, the anode header tab 138 protrudes taller than the other anodes from an outermost anode straight tab or tabbed portion (an outermost tab being a tab connected to an anode that is not sandwiched by two other anodes in the electrode stack). The header tabs are shown bent, but they are preferably not bent until after a header is installed.

FIG. 10 shows a method of an enclosed, two-step weld for connecting the cathodes in an electrode stack to a header 234. In the method, the header 234 has a pin 232 extending perpendicular to the major plane of the header 234. The pin 232 is inserted between the triangle tabs 202 which are pressed together and welded with the pin 232 in between two of the triangle tabs 202. This may cause weld spatter 233, a problem which may occur when welding metals within tightly enclosed spaces, such as a pin 232 within enclosed triangle tabs 202.

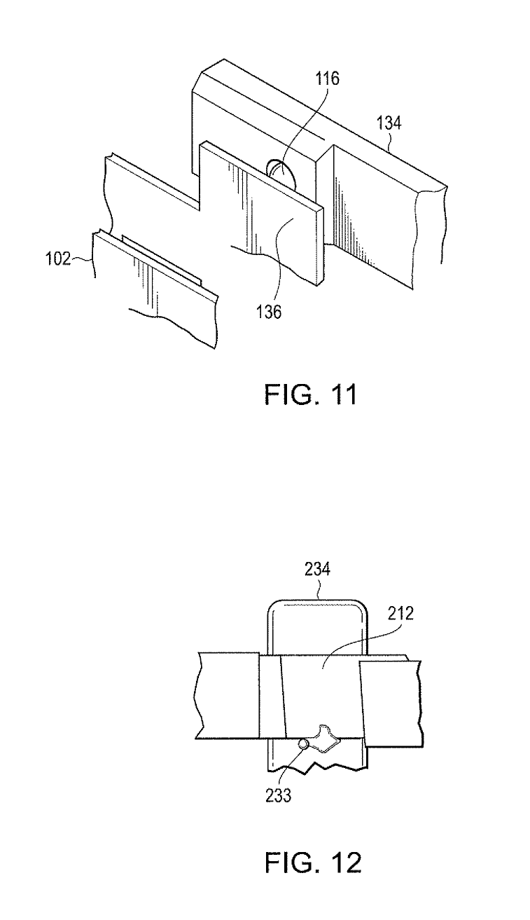

FIG. 11 shows an open-face weld for the cathode header tab 136 in a preferred embodiment. In the open-face layered assembly method for stacking the electrodes, the cathode header tab 136 has an outward-facing (away from the assembly 132), openly accessible face while secured by the assembly 132 and alignment rods 120. Forming the cathodes 108 with flag tabs 102 yields a significant and repeatable feature to secure the cathodes 108 during welding. The open-face layered assembly method minimizes lateral movement of the cathodes 108 during welding since the alignment rods 118 secure the cathodes 108 while they are on the assembly 132. Thus, the cathode header tab 136 can be open-face welded to the pin 140 of the header 134, which minimizes weld spatter 233 since the pin 140 is welded only to a single cathode header tab 136 (rather than within multiple cathode tabs as in FIG. 10). Alternatively, the cathode header tab 136 can be welded directly to the header 134—this would also reduce weld spatter 233.

FIG. 12 shows a method of resistance welding an anode to a header 234. In the method, a straight tab 212 of an anode (not shown) is resistance welded to a header 234 by spanning the width of the header 234 with the straight tab 212.

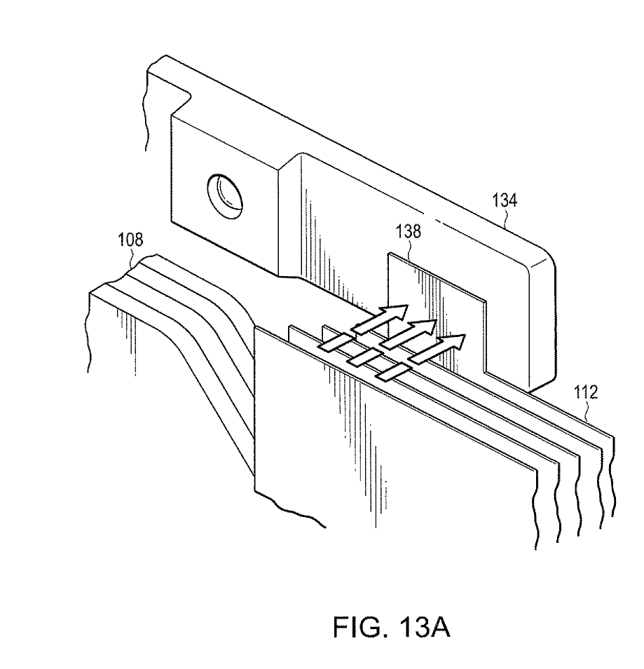

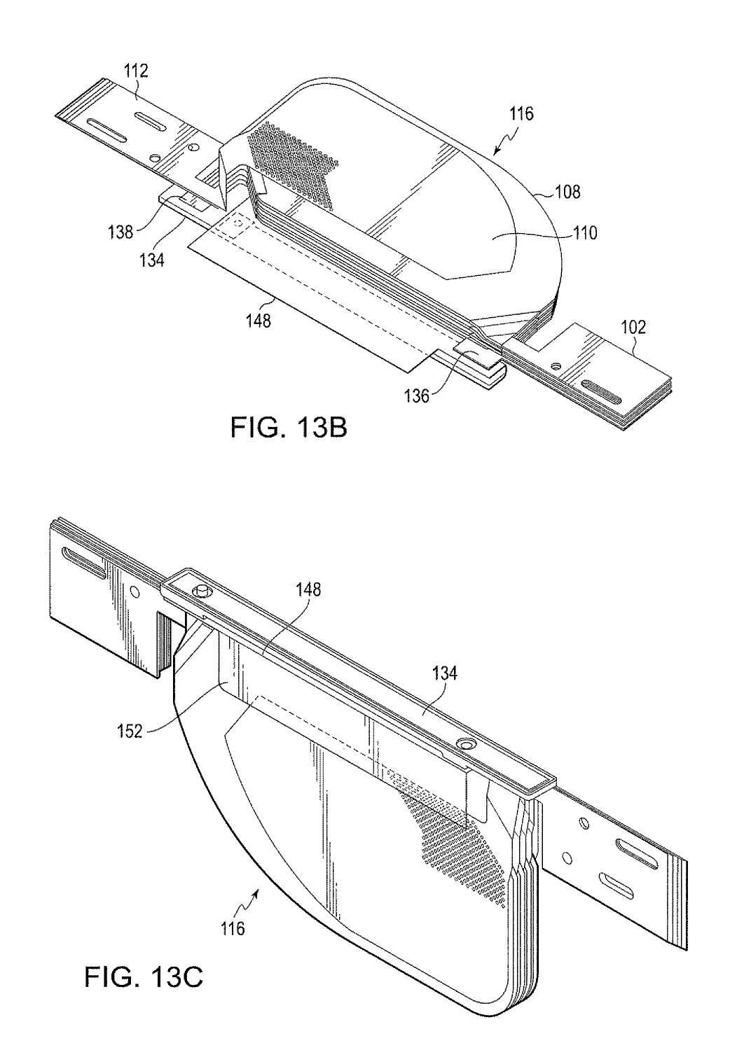

FIG. 13A shows an open-face weld for the anode header tab 138 in an embodiment. In the open-face layered assembly method for stacking the electrodes, the anode header tab 138 has an outward-facing (away from the assembly 132), open accessible face. Further, the open-face layered assembly method minimizes lateral movement of the anodes 110 during welding since the alignments rods 120 secure the anodes 110 while they are on the assembly 132. Thus, the anode header tab 138 can be open-face welded to the header 134, which minimizes weld spatter 233, an undesired and problematic effect. Alternatively, the anode header tab 138 can be welded to a pin of the header 134—this would also reduce weld spatter 233.

FIG. 13B shows a wing insulator 148 in an embodiment. The wing insulator 148 insulates the electrode stack 116 from the header 134 and cell housing (not shown) and is preferably installed before welding the cathode header tab 136 and anode header tab 138 to the header 134. The cathode header tab 136 and anode header tab 138 may be attached to the wing insulator 148 instead of to the header 134 in any of the embodiments herein. If so, then the wing insulator 148 is attached to the header 134. The wing insulator 148 may initially be a flattened piece of material as shown in FIG. 13B that is subsequently bent to enclose a thickness edge of the electrode stack 116 as shown in FIG. 13C. The wing insulator 148 includes a spine with a width preferably substantially equal to a thickness of the electrode stack, and at least two wings 152 extending preferably substantially perpendicular to a major plane of the spine, the at least two wings 152 preferably enclosing a thickness edge of the electrode stack 116 and at least a portion of both faces of the electrode stack 116.

The natural property of cathodes to expand in size may disturb the alignment of electrodes and thereby the proper functioning of an electrochemical cell during use. Exemplary embodiments for mitigating disruptions in battery performance caused by expanding cathodes are discussed below.

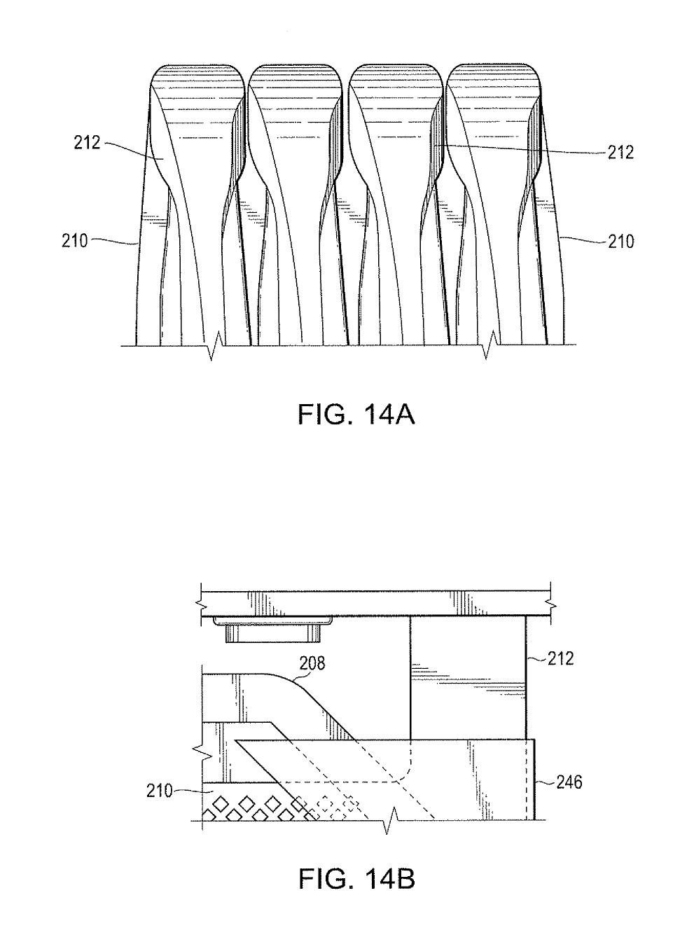

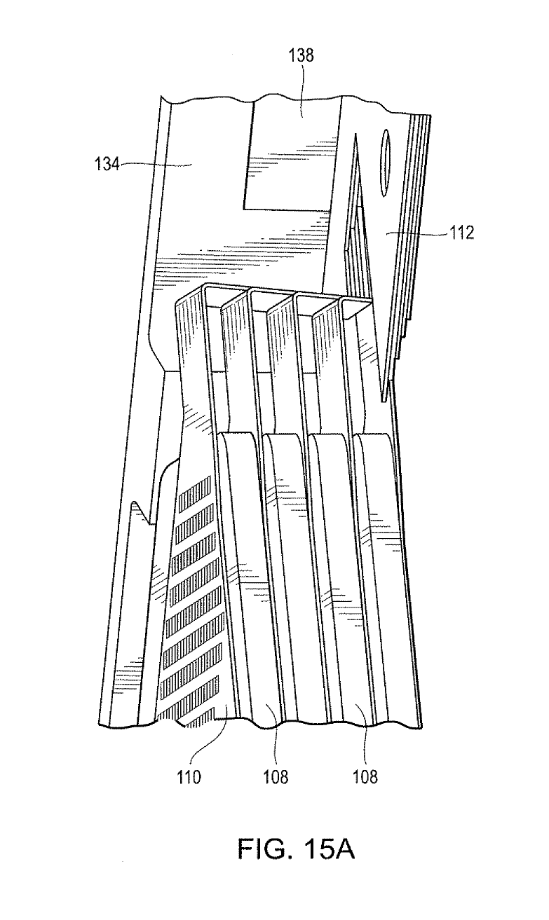

FIG. 14A shows a method of bending anode tabs so that the anodes are in physical contact with each other. In this method, the straight tabs 212 of the anodes 210 are crushed together so that they are in contact with each other.

FIGS. 15A-15D show embodiments that mitigate the effects of cathode expansion. FIG. 15A shows tabbed portions 112 of the anodes 110 in an embodiment. The shown tabbed portions 112 are bent substantially parallel to a thickness plane of the electrode stack so as to leave sufficient space for cathode expansion. However, the tabbed portions 112 may be bent at any angle so as to leave sufficient space for cathode expansion. Preferably, the tabbed portions 112 are bent such that at least a portion of each tabbed portion makes a substantially 55° angle with a major plane of a nearest cathode 108.

FIG. 15B shows tabbed portions 112 of the anodes 110 in an embodiment. The shown tabbed portions 112 are bent so that the bend line 144 is substantially parallel to an edge of a cathode 108. The edge may belong to any of the cathodes. The bend line 144 is created at a predetermined distance 142 from the edge of, preferably, the nearest cathode. This reduces or eliminates the possibility for a short circuit due to cathode expansion. The predetermined distance 142 is preferably the smallest distance that it can be while still allowing a sufficient “safe zone” for cathode expansion. Minimizing the distance under the foregoing constraint allows for a larger cathode and therefore a more powerful cell. The predetermined distance is preferably a function of a pre-calculated cathode expansion. Thus, one such minimum distance may be 0.100 inch, and the distance is unlikely to exceed 0.500 inch except in extreme circumstances of cathode expansion. The flag tabs 102 may be similarly bent as shown in FIG. 15C, which shows a top view of an embodiment in which all of the flag tabs 102 and all of the tabbed portions 112 are bent.

FIG. 14B shows a method of accounting for cathode expansion. In the method, electrically-insulating anode tape 246 is placed on the anode 210 so that an expanding cathode 208 will not make direct contact with the crushed anode material. However, this may require manual placement of the anode tape 246 depending on the variation in how the anode material was crushed, which may be unpredictable. Further, the expanding cathode may simply exceed the edge of the anode tape 246 and make direct contact with the anode 210.

FIG. 15D shows a cathode 108 with an electrically-insulating material 146 applied to the edge of the cathode nearest the bent portion of the anode 110 in a preferred embodiment. Providing the electrically-insulating material 146 on the cathode edge prevents the expanding cathode from directly contacting any part of the anode 110 since the material 146 moves as the cathode 108 expands. Therefore, the cathode cannot exceed the coverage of the material 146 during expansion. Preferably as shown, the electrically-insulating material entirely encapsulates the edge of the cathode 108 closest to the bent portion of the anode 110. The electrically-insulating material may be electrically-insulating tape.

The embodiment of FIGS. 15A-15D addresses misalignment of anodes due to relative lack of control over how the material reforms under crushing pressure. For example, the crushing may apply a lateral load on the cathodes thereby misaligning the cathodes. Additionally, the crushed material may interfere with cathode expansion during discharge of the electrochemical cell, since the direction the material crushes is highly unpredictable. The preferred methods for bending tabbed portions also mitigate or eliminate problems associated with cathodes that expand to contact the crushed material, which is essentially part of the anodes (i.e., a short circuit).

FIG. 16 shows an electrode stack 116 in an embodiment. In this embodiment, the flag tabs and tabbed portions are processed so as to rid the electrode stack 116 of protrusions that would prevent the electrode stack 116 from fitting within an electrochemical cell housing (not shown). Preferably, the processing is performed after all electrodes have been aligned on the alignment rods. Preferably, the flag tabs and tabbed portions are cut off by any number of known cutting devices including, but not limited to, saws, industrial blades, and laser.

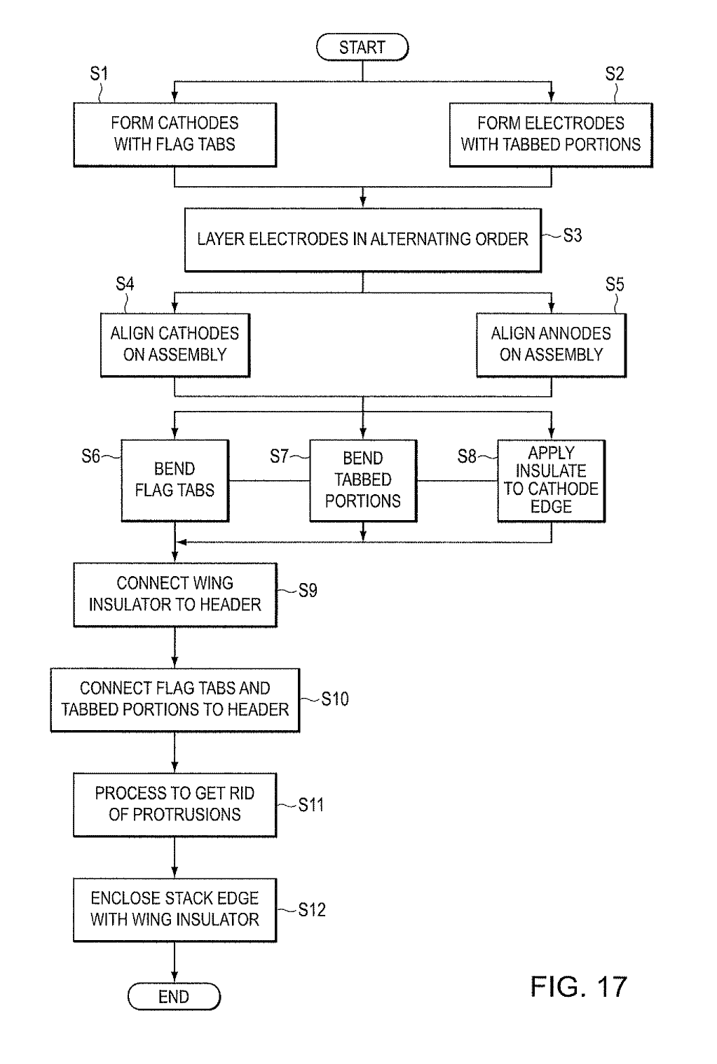

FIG. 17 is a flowchart showing a method of an embodiment. In the method, a plurality of cathodes that each include a flag tab that defines at least one flag tab tooling hole and a plurality of anodes that each include a tabbed portion that defines at least one tabbed portion tooling hole are formed (steps S1 and S2). Then, the cathodes and the anodes are stacked to create an electrode stack. The stacking includes layering in alternating order the anodes and the cathodes with at least one layer of separator physically insulating each anode from each cathode (steps S3), aligning the cathodes by inserting at least one flag tab alignment rod through the at least one flag tab tooling hole of each flag tab (step S4), and aligning the anodes by inserting at least one tabbed portion alignment rod through the at least one tabbed portion tooling hole of each tabbed portion (step S5). Then, each of steps S6 through S8 may be optionally performed to further improve the resulting battery. The tabbed portions are bent at a first predetermined distance from the nearest cathode sufficient to allow for the cathode to expand to a predetermined size without making contact with the tabbed portions (step S6), the flag tabs are bent at a second predetermined distance from a main body of a nearest cathode sufficient to allow for the cathode to expand to a predetermined size without making contact with the flag tabs (step S7), and an insulate is applied to the an edge of a cathode (step S8).

Then, an edge of the electrode stack is enclosed with a wing insulator (step S9). Then, flag tabs and tabbed portions are connected to the wing insulator (step S10). Then, the wing insulator is connected to a stabilizing header (step S11). Then, the electrode stack is processed to rid the stack of protrusions that prevent it from fitting within an electrochemical cell housing (step S12). Some of the steps may be omitted and additional steps can be added as disclosed in embodiments. For example, the method may include folding the header substantially perpendicular to the electrode stack. As another example, step S9 may be omitted. Furthermore, the order of the steps may vary without departing from exemplary embodiments. For example, the processing (step S11) may be performed before connecting the wing insulator to the header. As another example, any of steps S6 through S8 may be performed in any permutation.

Batteries manufactured with the foregoing embodiments have at least the following advantages. Because stacked batteries manufactured with the foregoing embodiments are assembled with more care and precision in aligning the electrodes, the electrode stacks are more tightly assembled resulting in higher rates of capacity and lower risk of shorts. The battery cells tend to have a larger electrode size in the same size housing while minimizing risk of shorts and thus minimizing failure rates.

The illustrated exemplary embodiments of the batteries and methods of manufacture as set forth above are intended to be illustrative and not limiting. Various changes may be made without departing from the spirit and scope of the invention.

What is claimed is:

1. A method of manufacturing a battery, comprising the steps of:
forming a plurality of cathodes that each include a flag tab of a first securing profile;
forming a plurality of anodes that each include a tabbed portion of a second securing profile; and
stacking the cathodes and the anodes to create an electrode stack, the stacking including:
layering in alternating order the anodes and the cathodes with at least one layer of separator physically insulating each anode from each cathode,
aligning the cathodes with a first alignment means, and
aligning the anodes with a second alignment means.

2. The method of claim 1, wherein
the first securing profile includes at least one flag tab tooling hole;
the second securing profile includes at least one tabbed portion tooling hole;
the first alignment means includes at least one flag tab alignment rod; and
the second alignment means includes at least one tabbed portion alignment rod.

3. The method of claim 1, wherein
the forming of the cathodes includes (i) aligning each flag tab to a corresponding cathode by aligning the flag tab and the cathode with an alignment device, and (ii) welding each of the flag tabs to the corresponding cathode.

4. The method of claim 1, wherein
an anode and the corresponding tabbed portion define a unitary structure if the anode is made from one component, and
at least one component of the anode and the corresponding tabbed portion define a unitary structure if the anode is made from more than one component.

5. The method of claim 1, wherein
the step of aligning the cathodes occurs simultaneously with the step of aligning the anodes.

6. The method of claim 1, further comprising:
stabilizing the electrode stack with a header, wherein
the stacking step further includes welding at least one flag tab to a pin of the header using an open-face weld.

7. The method of claim 1, wherein
the stacking step further includes welding the plurality of tabbed portions together using an open-face gang weld.

8. The method of claim 1, further comprising:
stabilizing the electrode stack with a header, wherein
the stacking step further includes welding at least one tabbed portion to the header using an open-face weld.

9. The method of claim 1, wherein
the stacking step further includes
bending the tabbed portions at a first predetermined distance from the nearest cathode sufficient to allow for the cathode to expand to a predetermined size without making contact with the tabbed portions; and
bending the flag tabs at a second predetermined distance from a main body of a nearest cathode sufficient to allow for the cathode to expand to a predetermined size without making contact with the flag tabs.

10. The method of claim 9, wherein
the bending step includes (1) making a plurality of bends in the tabbed portions parallel to a first edge of a cathode, and (2) making a plurality of bends in the flag tabs parallel to a second edge of the cathode.

11. The method of claim 9, wherein
the predetermined distance is no greater than 0.500 inch.

12. The method of claim 9, wherein
the stacking step further includes wrapping a portion of the edges of the cathodes closest to the tabbed portions with an electrically-insulating material.

13. The method of claim 1, further comprising:
processing the flag tabs and the tabbed portions so as to rid the electrode stack of protrusions that would prevent the electrode stack from fitting within an electrochemical cell housing.

14. The method of claim 13, wherein
the processing step includes cutting off the flag tabs from the cathodes and the tabbed portions from the anodes.

15. The method of claim 1, further comprising:
encapsulating at least one edge of the electrode stack with a wing insulator that includes (1) a spine with a width substantially equal to a thickness of the electrode stack, and (2) at least two wings extending substantially perpendicular to a major plane of the spine, the at least two wings enclosing a thickness edge of the electrode stack and at least a portion of both faces of the electrode stack;
insulating the electrode stack from a header and/or an electrochemical cell housing with the wing insulator; and
stabilizing the electrode stack with the header.

16. A battery manufactured by the method of claim 1.

17. An assembly for manufacturing a battery comprising:
first forming means for forming a plurality of cathodes that each include a flag tab of a first securing profile;
second forming means for forming a plurality of anodes that each include a tabbed portion of a second securing profile; and
stacking means for stacking the cathodes and the anodes to create an electrode stack, the stacking including:
first aligning means for aligning the cathodes, and
second aligning means for aligning the anodes,
wherein the anodes and the cathodes are layered in alternating order with at least one layer of separator physically insulating each anode from each cathode.
